(19) United States
(12) Patent Application Publication
(10) Pub. No.: US 2025/0229793 A1
(43) Pub. Date: Jul. 17, 2025

(54) Method and Device for Controlling the Availability of a Driver Assistance Function

(71) Applicant: Bayerische Motoren Werke Aktiengesellschaft, Muenchen (DE)

(72) Inventors: Frederik NAUJOKS, Muenchen (DE); Andreas KEINATH, Muenchen (DE)

(21) Appl. No.: 18/684,975

(22) PCT Filed: Jul. 25, 2022
(86) PCT No.: PCT/EP2022/070721

§ 371 Date: Feb. 20, 2024

(30) Foreign Application Priority Data
Aug. 26, 2021 (DE) 10 2021 122 050.5

(51) Int. Cl. B60W 50/12; B60W 40/02; B60W 50/00; B60W 50/14; B60W 60/00

(52) U.S. Cl. CPC B60W 50/12; B60W 40/02; B60W 50/14; B60W 60/0053; B60W 60/0057; B60W 2050/0083; B60W 2540/215; B60W 2552/05; B60W 2555/20; B60W 2556/40

(57) ABSTRACT

A device for providing a driver assistance function of a motor vehicle is configured to determine a user-specific availability profile in relation to a user-related availability of the driver assistance function. The device is also configured to operate the driver assistance function depending on the user-specific availability profile, in particular to block or release the driver assistance function.

### BACKGROUND AND SUMMARY

The invention relates to a method and a corresponding device for controlling the availability of a driver assistance function, in particular a driving function for at least partially automated longitudinal and/or lateral guidance, of a motor vehicle.

A vehicle may have one or more driving functions that are designed to effect at least partially automated longitudinal and/or lateral guidance of the vehicle. The availability of a driving function in this case may be reduced in a specific route section owing to current weather conditions, owing to current light conditions, owing to the current traffic situation and/or owing to infrastructure conditions in the route section. The reduced availability of the driving function may lead to reduced convenience for the user, in particular for the driver, of the vehicle.

The present document is concerned with the technical problem of efficiently increasing convenience for a user of a driver assistance function, in particular a driving function, in regard to the availability of the driving function.

The problem is solved by the claimed invention. It is pointed out that additional features of a patent claim dependent on an independent patent claim without the features of the independent patent claim or only in combination with a subset of the features of the independent patent claim may form a dedicated invention that is independent of the combination of all features of the independent patent claim and that may be made the subject of an independent claim, of a divisional application or of a subsequent application. This applies in the same way to technical teachings that are described in the description and that may form an invention that is independent of the features of the independent patent claims.

According to one aspect, a (control) device for providing a driver assistance function of a motor vehicle is described. The device may be configured in particular to control the availability of the driver assistance function (on the basis of a preference of a user, in particular the driver, of the vehicle). The availability of the driver assistance function may indicate and/or be dependent on the use situations, in particular the route sections of the road network that the vehicle is using, in which the driver assistance function is enabled (and therefore able to be used).

The driver assistance function may comprise a driving function that is designed to longitudinally and/or laterally guide the vehicle in an at least partially automated manner, in particular according to SAE level 1 or more, or according to SAE level 2 or more, or according to SAE level 3 or more. Alternatively or additionally, the driver assistance function may comprise an information function that is designed to ascertain and provide the user with (driving-related) information, in particular information relating to road signs on a road that the vehicle is using.

The device is configured to ascertain a user-specific availability profile relating to a user-related availability, in particular relating to an availability desired by the user, of the driver assistance function. The availability profile may have been stipulated by the user in advance. The device may be configured e.g. to use a user interface of the vehicle to acquire a user input from the user for stipulating and/or adapting the user-specific availability profile. Alternatively or additionally, the user-specific availability profile may be ascertained at least in part by observing the behavior of the user. The availability profile may be stored in a memory unit of the vehicle.

The device may therefore be configured to allow a user to configure and/or adapt the user-specific availability profile and the resultant availability of the driver assistance function. The configuring and/or adapting may be performed using a user interface of the vehicle.

The availability profile may comprise one or more parameters that stipulate when and/or how and/or where the driver assistance function is supposed to be available or is not supposed to be available. The availability profile may indicate or stipulate the preferences for the availability of the driver assistance function that have been explicitly or implicitly stipulated by the user.

In addition, the device is configured to operate, in particular disable or enable, the driver assistance function on the basis of the user-specific availability profile. In other words, the driver assistance function may be made available for use by the user, in particular by the driver, on the basis of the user-specific availability profile.

The device therefore allows a user to use an availability profile to stipulate preferences as to when and/or where a specific driver assistance function is supposed to be enabled or disabled. If necessary, a function-specific availability profile may be stipulated for each of different driver assistance functions. This allows convenience for the user when using driver assistance functions to be efficiently increased.

The device may be configured to disable or enable the driver assistance function for use in a specific use situation on the basis of the availability profile. The specific use situation in this case may be described by one or more situation parameters, in particular by parameter values for one or more situation parameters.

Illustrative situation parameters are a location parameter (e.g. GNSS coordinates) for identifying a route section in the road network that the vehicle is using; a road parameter for describing a road, in particular a road type, of a road that the vehicle is using (such as e.g. a freeway, a country road or a downtown road); an infrastructure parameter for describing the merit of a road that the vehicle is using, in particular in regard to a road marking and/or in regard to a road sign; a light parameter for describing a light situation, in particular day, night or twilight; a weather parameter for describing a weather situation, in particular rain, snow, fog, sun or cloud; and/or a visibility parameter for describing a visibility situation, in particular a visibility.

It is therefore possible to allow a user to precisely stipulate the one or more use situations in which the driver assistance function is supposed to be disabled or enabled. In particular, it is possible to allow the user to explicitly stipulate parameter values for one or more situation parameters in the availability profile in order to define one or more use situations in which the driver assistance function is supposed to be disabled or alternatively enabled. This allows convenience for the user to be increased further.

The device may therefore be configured to allow a user to stipulate and/or adapt user-specific parameter values for one or more situation parameters in the user-specific availability profile in order to describe one or more user-specific use situations in which the driver assistance function is supposed to be disabled or enabled. This allows the user-specific availability of the driver assistance function to be stipulated particularly precisely.

In addition, the device may be configured to ascertain current parameter values for one or more situation parameters for describing a current use situation, in particular on the basis of environmental data from one or more environment sensors of the vehicle. It is then particularly precisely and reliably possible to take the current parameter values and to take the user-specific availability profile, in particular to take the user-specific parameters from the user-specific availability profile, as a basis for determining whether the driver assistance function is able to be operated with sufficiently high reliability in the current use situation.

As an alternative or in addition to the explicit stipulation of parameter values for one or more situation parameters, the user-specific availability profile may indicate a maximum statistical frequency of terminations, takeover requests and/or errors in the driver assistance function that is accepted by the user. In other words, it is possible to allow the user to stipulate how often (e.g. with what frequency) at most the driver assistance function is allowed to be terminated, is allowed to generate takeover requests and/or is allowed to be erroneous.

The device may be configured to check whether the driver assistance function is statistically able, in the current use situation, to be operated with a reliability that complies with the maximum accepted statistical frequency of terminations, takeover requests and/or errors in the driver assistance function that is indicated by the user-specific availability profile.

For this purpose, reliability data ascertained in advance relating to the reliability of the driver assistance function may be taken into account. In particular, the reliability data may be used to check whether the driver assistance function is able to be operated with sufficiently high reliability in the current use situation. The reliability data may have been ascertained in advance on the basis of measurements. The reliability data may be stored in a memory unit of the vehicle.

The reliability data may in each case take one or more situation parameters, in particular parameter values for one or more situation parameters, for describing a use situation as a basis for indicating a statistical frequency of terminations, takeover requests and/or errors in the driver assistance function.

The device may be configured to ascertain parameter values for one or more situation parameters for describing the current use situation. The parameter values may be ascertained in particular on the basis of environmental data from one or more environment sensors (e.g. a camera, a radar sensor, a lidar sensor, a GNSS receiver, a light sensor, etc.) of the vehicle. The reliability data and the ascertained parameter values may then be used to check whether the driver assistance function is able to be operated with sufficiently high reliability in the current use situation.

In addition, the device may be configured to disable or enable the driver assistance function in the current use situation on the basis of the checking. This allows convenience for the user to be increased further.

Alternatively or additionally, the user-specific availability profile may indicate a type of road, in particular freeway, country road and/or road in a town, for which the driver assistance function is supposed to be disabled or enabled. Alternatively or additionally, the user-specific availability profile may indicate a specific route section of the road network that the vehicle is using in which the driver assistance function is supposed to be disabled or enabled. It is therefore possible to allow a user to explicitly enable or disable types of roads and/or route sections for use of the driver assistance function. This allows convenience for the user to be increased further.

The device may be configured to take a digital map relating to the road network that the vehicle is using as a basis for checking whether the driver assistance function is disabled or enabled as standard in a current route section. The digital map may be provided by a manufacturer of the vehicle (e.g. via a digital communication connection).

The device may furthermore be configured to take the user-specific availability profile as a basis for checking whether the driver assistance function has been enabled or disabled by the user in the current route section contrary to the standard disablement or enablement in the digital map. The driver assistance function may then be enabled or disabled for use in the current route section according to the user-specific availability profile (and possibly contrary to the digital map). It is therefore possible to allow a user to stipulate in the user-specific availability profile an enablement or a disablement of the driver assistance function that is contrary to the standard stipulation. This allows convenience for the user to be increased further.

The device may be configured to ascertain use data relating to the actual use of the driver assistance function by the user. It is therefore possible to observe how the user actually uses the driver assistance function. Furthermore, the tolerance of the user in regard to terminations, takeover requests and/or errors in the driver assistance function may be observed and/or ascertained as part of the use data.

In addition, the device may be configured to take the use data as a basis for suggesting or automatically effecting an adaptation of the user-specific availability profile. The adaptation of the availability profile may comprise in particular the inclusion of a disabled or enabled route section in the user-specific availability profile. Alternatively or additionally, the adaptation of the user-specific availability profile may comprise the adaptation of the maximum statistical frequency of terminations, takeover requests and/or errors in the driver assistance function that is accepted by the user. The user may therefore be assisted in stipulating the user-specific availability profile, thereby further increasing convenience for the user.

The user-specific availability profile may indicate the minimum takeover time as a result of a takeover request from the driver assistance function that is desired by the user. In other words, it is possible to allow the user to individually stipulate the minimum takeover time that should be available for the user to take over the driving task when the driver assistance function is terminated.

The device may be configured to enable or disable the driver assistance function in different use situations such that in each case the takeover time required for operation of the driver assistance function in the respective use situation is not less than the minimum desired takeover time. In particular, the device may be configured to ascertain for a specific use situation the takeover time required for the specific use situation (e.g. which is required for the user to safely take over the driving task). It is then possible to check whether the required takeover time is longer or shorter than the minimum desired takeover time stipulated in the user-specific availability profile. If the required takeover time is shorter than the minimum desired takeover time, the driver assistance function may be disabled in the specific use situation. If, on the other hand, the required takeover time is longer than the minimum desired takeover time, then the driver assistance function may be enabled in the specific use situation.

The user-specific stipulation of the minimum desired takeover time allows convenience for the user to be increased further.

According to another aspect, a (road) motor vehicle (in particular a passenger vehicle or a truck or a bus or a motorcycle) is described that comprises the device described in this document.

According to another aspect, a method for providing a driver assistance function of a motor vehicle is described. The method comprises ascertaining a user-specific availability profile relating to a user-related availability, in particular relating to an availability desired by a user, of the driver assistance function. The availability profile may be read e.g. from a memory unit of the vehicle. In addition, the method comprises operating, in particular enabling or disabling, the driver assistance function on the basis of the user-specific availability profile.

According to another aspect, a software (SW) program is described. The SW program may be configured to be executed on a processor (e.g. on a control unit of a vehicle) and to thereby carry out the method described in this document.

According to another aspect, a storage medium is described. The storage medium may comprise an SW program that is configured to be executed on a processor and to thereby carry out the method described in this document.

The term “automated driving” may be understood within the context of the document to mean driving with automated longitudinal or lateral guidance or autonomous driving with automated longitudinal and lateral guidance. Automated driving may be for example driving over an extended period of time on the freeway or driving over a limited period of time when parking or maneuvering. The term “automated driving” covers automated driving with any level of automation. Illustrative levels of automation are assisted, partially automated, highly automated or fully automated driving. These levels of automation have been defined by the German Federal Highway Research Institute (BASt) (see BASt publication “Forschung kompakt”, issue 11/2012). In the case of assisted driving, the driver performs the longitudinal or lateral guidance on an ongoing basis, while the system undertakes the respective other function within certain boundaries. In the case of partially automated driving (TAF), the system undertakes the longitudinal and lateral guidance for a certain period of time and/or in specific situations, the driver needing to monitor the system on an ongoing basis as in the case of assisted driving. In the case of highly automated driving (HAF), the system undertakes the longitudinal and lateral guidance for a certain period of time without the driver needing to monitor the system on an ongoing basis; however, the driver must be capable of taking over vehicle guidance within a certain time. In the case of fully automated driving (VAF), the system may automatically cope with driving in all situations for a specific application; a driver is no longer needed for this application. The aforementioned four levels of automation correspond to SAE levels 1 to 4 of SAE standard J3016 (SAE—Society of Automotive Engineering). By way of example, highly automated driving (HAF) corresponds to level 3 of SAE standard J3016. Furthermore, SAE J3016 also has provision for SAE level 5 as the highest level of automation, which is not included in the definition from the BASt. SAE level 5 corresponds to driverless driving, in which the system may automatically cope with all situations throughout the journey in the same way as a human driver; a driver is generally no longer needed.

It should be noted that the methods, devices and systems described in this document may be used alone or in combination with other methods, devices and systems described in this document. In addition, any aspects of the methods, devices and systems described in this document may be combined with one another in a variety of ways. In particular, the features of the claims may be combined with one another in a variety of ways. Furthermore, features shown between parentheses may be understood as optional features.

The invention is described in more detail below on the basis of exemplary embodiments.

### BRIEF DESCRIPTION OF THE DRAWINGS

FIG. 1 shows an illustrative vehicle having a driver assistance function.

FIG. 2 shows a flowchart for an illustrative method for controlling the availability of a driver assistance function of a vehicle.

### DETAILED DESCRIPTION OF THE DRAWINGS

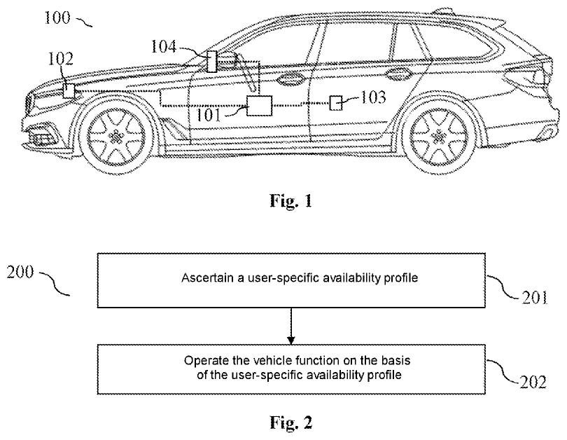

As explained at the outset, the present document is concerned with reducing losses of convenience for a user owing to limited or excessively high availability of a driver assistance function of a vehicle. In this context, FIG. 1 shows an illustrative vehicle 100 that comprises one or more environment sensors 102 that are configured to capture environmental data (i.e. sensor data) relating to the environment of the vehicle 100. Illustrative environment sensors 102 are a camera, a radar sensor, a lidar sensor, an ultrasonic sensor, etc.

A (control) device 101 of the vehicle 100 may be configured to take the environmental data as a basis for providing at least one driving function for the at least partially automated guidance of the vehicle 100. The driving function may in particular be a driver assistance function. An illustrative driving function is automatic speed adaptation for a speed limit detected by the vehicle 100 (in particular an intelligent speed adapter, ISA). Another illustrative driving function is a lane assist system, which is designed to keep the vehicle 100 in a current lane in an automated manner.

The device 101 of the vehicle 100 may be configured to operate one or more longitudinal and/or lateral guidance actuators 103 (e.g. a steering device, a drive motor, a braking device, etc.) on the basis of the environmental data in order to provide the driving function, in particular in order to effect automatic intervention in the longitudinal and/or lateral guidance of the vehicle 100.

The functional merit of a driving function (in particular a driving function according to SAE level 2 or 3) is typically dependent on one or more external factors. Illustrative external factors are: one or more conditions relating to the infrastructure, relating to the weather, relating to the visibility conditions and/or relating to the light conditions. The merit of a driving function in a specific route section may be dependent in particular on how good or new the road markings in the route section are; whether there is a road-design division between different lanes in the route section; whether the one or more road signs in the route section are new and easily recognizable; and/or what the current weather conditions are like.

Good conditions for a driving function to be available and to work require the driving function to reach its system limit less often and to output a takeover request in response thereto. Alternatively or additionally, the time window available to a user to intervene in the vehicle guidance in the case of a system limit is typically dependent on the one or more external conditions.

For a driving function, infrastructure conditions and/or weather conditions may therefore affect how often recognition errors and/or function terminations occur. For this reason, restrictions may be placed on when or where the driving function is actually able to be activated (and therefore available). The operation of the driving function may therefore be dependent on the location in which the vehicle 100 is situated (so-called geofencing).

The location-dependent disablement or enablement of a driving function may lead to a user who would accept relatively frequent takeover requests and/or relatively short time windows for takeover being restricted in the use of the driving function at a location at which the driving function is disabled. On the other hand, it may be that relatively frequent takeover requests or relatively frequent errors in the driving function occur in an enabled route section, and the user would actually restrict the availability of the driving function in this route section. This may also be the case with a driving function for which only information (such as e.g. the speed limit) is output, but no automated intervention in the longitudinal and/or lateral guidance of the vehicle 100 takes place (as possibly in the case of intelligent speed adaptation). Here, it may happen for example that road signs in a specific route section are repeatedly recognized incorrectly.

The vehicle 100 comprises a user interface 104 that allows a user, in particular the driver, of the vehicle 100 to stipulate one or more preferences relating to the availability of at least one driving function. In other words, it is possible for the user to be allowed to stipulate a user-specific profile relating to the availability of a driving function. The user-specific availability profile for a specific driving function may be used to stipulate in particular a route section in which the driving function is supposed to be disabled (i.e. not able to be activated) (i.e. a so-called blacklist); a route section in which the driving function is supposed to be able to be activated (i.e. a so-called white list); a maximum permissible (statistical and/or average) frequency of takeover requests and/or errors in the driving function (possibly per route section); and/or a minimum permissible takeover time for takeover owing to a takeover request (possibly per route section).

The driving function may then be operated on the basis of the user-specific availability profile. In particular, the device 101 may be configured to use the user-specific availability profile to check whether the driving function is enabled or disabled in a specific route section that the vehicle 100 is using. Alternatively or additionally, the device 101 may be configured to ascertain the actual frequency of takeover requests and/or errors in a route section and to compare it with the maximum permissible frequency from the user-specific availability profile. The driving function may then be enabled or disabled in the route section on the basis of the comparison.

Alternatively or additionally, the device 101 may be configured to operate the driving function with the minimum permissible takeover time from the user-specific availability profile in order to increase the availability of the driving function within the framework of use acceptable to the user.

A method is therefore described that allows a user to configure the system availability of an automated driving system (SAE level 1 to level 3) or of a driver information system (e.g. ISA) according to their preferences, so that the respective system is available and/or active more often or less often on a user-specific basis.

The availability of a driver assistance function is therefore not predefined identically for all users in a general way, but rather may be individualized for single users. A user-specific availability profile may be used to stipulate general route features for the desired availability (such as e.g. use of the driver assistance function only on freeways, not on country roads or downtown, or only in good weather, or during the day and not at night). Furthermore, specific route sections (for example frequently used route sections) on which system failure is often detected may be deselected and/or disabled, which means that there is no system availability in these route sections. On the other hand, route sections that are not enabled by default because excessively frequent system outage or excessively frequent recognition errors for control objects is/are expected may themselves be enabled, which means that the time in which the driver assistance function may be used is optimized on a user-specific basis.

The device 101 may be configured to statistically ascertain the use behavior of a user in regard to a driver assistance function, in particular a driving function. In particular, it is possible to ascertain whether or not the user accepts relatively frequent takeover requests and/or errors in the driver assistance function. The system may then suggest to the user that a specific route section be enabled or that one or more activation conditions be enabled.

FIG. 2 shows a flowchart for a (possibly computer-implemented) method 200 for providing a driver assistance function of a motor vehicle 100. The method 200 is geared in particular to controlling the availability of the driver assistance function. The method 200 comprises ascertaining 201 a user-specific availability profile relating to a user-related availability, in particular relating to an availability desired by a user, of the driver assistance function. The availability profile may have been stipulated by the user (e.g. using a user interface 104 of the vehicle 100). Alternatively or additionally, the availability profile may have been ascertained at least partially automatically on the basis of an identified user behavior during use of the driver assistance function. The availability profile may be stored on a memory unit of the vehicle 100. The availability profile may indicate one or more route sections in which the driver assistance function has been enabled or disabled for use by the user. Alternatively or additionally, the availability profile may indicate the tolerance of the user in regard to terminations, takeover requests, takeover times and/or errors in the driver assistance function.

The method 200 furthermore comprises operating 202, in particular disabling or enabling, the driver assistance function on the basis of the user-specific availability profile. For this purpose, the use situation, e.g. the route section, that the vehicle 100 is currently in or will be in may be ascertained. The user-specific availability profile may then be taken as a basis for deciding whether the driver assistance function is enabled or disabled for the current use situation.

The measures described in this document allow a user of an automated vehicle system in the SAE level 1, 2 or 3 category to adapt the availability of the driver assistance in line with the needs of the user, which means that the vehicle system may be deactivated on a user-specific basis in a route section that, by way of example, exhibits relatively poor maintenance and insufficiently visible road markings.

Furthermore, the user-specific enablement or disablement of a driving function allows the user to have to intervene less often as a result of a takeover request and/or allows the driving function to be used more often. This allows convenience and use ergonomics to be increased.

The present invention is not limited to the exemplary embodiments shown. In particular, it should be noted that the description and the figures are supposed to illustrate the principle of the proposed methods, devices and systems only by way of example.

1.-16. (canceled)

17. A device for providing a driver assistance function of a motor vehicle, wherein the device is configured:
to ascertain a user-specific availability profile relating to a user-related availability of the driver assistance function; and
to disable or enable the driver assistance function based on the user-specific availability profile.

18. The device according to claim 17, wherein the device is further configured to allow a user to configure and/or adapt the user-specific availability profile and a resultant availability of the driver assistance function.

19. The device according to claim 17, wherein:
the device is further configured to disable or enable the driver assistance function for use in a specific use situation based on the user-specific availability profile; and
the specific use situation is described by one or more situation parameters.

20. The device according to claim 19, wherein the device is further configured to allow a user to stipulate and/or adapt user-specific parameter values for one or more situation parameters in the user-specific availability profile in order to describe one or more user-specific use situations in which the driver assistance function is supposed to be disabled or enabled.

21. The device according to claim 19, wherein the device is further configured:
to ascertain current parameter values for one or more situation parameters for describing a current use situation based on environmental data from one or more environment sensors of the vehicle; and
to take the current parameter values and to take the user-specific availability profile as a basis for determining whether the driver assistance function is able to be operated with sufficiently high reliability in the current use situation.

22. The device according to claim 19, wherein the one or more situation parameters comprise:
a location parameter for identifying a route section in a road network that the vehicle is using;
a road parameter for describing a road type of a road that the vehicle is using;
an infrastructure parameter for describing a merit of a road that the vehicle is using, in regard to a road marking and/or in regard to a road sign;
a light parameter for describing a light situation;
a weather parameter for describing a weather situation; and/or
a visibility parameter for describing a visibility situation.

23. The device according to claim 22, wherein the light situation is day, night or twilight.

24. The device according to claim 22, wherein the weather situation is rain, snow, fog, sun or cloud.

25. The device according to claim 22, wherein the visibility situation is a visibility.

26. The device according to claim 17, wherein:
the user-specific availability profile indicates a maximum statistical frequency of terminations, takeover requests and/or errors in the driver assistance function that is accepted by the user; and
the device is further configured:
to check whether the driver assistance function is statistically able, in a current use situation, to be operated with a reliability that complies with the maximum accepted statistical frequency of terminations, takeover requests and/or errors in the driver assistance function that is indicated by the user-specific availability profile; and
to take a result of the check as a basis for disabling or enabling the driver assistance function in the current use situation.

27. The device according to claim 26, wherein:
the device is further configured to use reliability data ascertained in advance relating to the reliability of the driver assistance function to check whether the driver assistance function is able to be operated with sufficiently high reliability in the current use situation; and
each of the reliability data take one or more situation parameters for describing a use situation as a basis for indicating a statistical frequency of terminations, takeover requests and/or errors in the driver assistance function.

28. The device according to claim 27, wherein the device is further configured:
to ascertain parameter values for one or more situation parameters for describing the current use situation based on environmental data from one or more environment sensors of the vehicle; and
to use the reliability data and to use the ascertained parameter values to check whether the driver assistance function is able to be operated with sufficiently high reliability in the current use situation.

29. The device according to claim 17, wherein the user-specific availability profile indicates:
a type of road for which the driver assistance function is supposed to be disabled or enabled; and/or
a specific route section of a road network that the vehicle is using in which the driver assistance function is supposed to be disabled or enabled.

30. The device according to claim 29, wherein the type of road is a freeway, a country road and/or a road in a town.

31. The device according to claim 17, wherein the device is further configured to use a user interface of the vehicle to acquire a user input from the user for stipulating and/or adapting the user-specific availability profile.

32. The device according to claim 17, wherein:
the driver assistance function comprises a driving function that is configured to longitudinally and/or laterally guide the vehicle in an at least partially automated manner, according to SAE level 1 or more, or according to SAE level 2 or more, or according to SAE level 3 or more; and/or
the driver assistance function comprises an information function that is configured to ascertain and provide the user with information relating to road signs on a road that the vehicle is using.

33. The device according to claim 17, wherein the device is further configured:
to take a digital map relating to a road network that the vehicle is using as a basis for checking whether the driver assistance function is disabled or enabled as standard in a current route section;
to take the user-specific availability profile as a basis for checking whether the driver assistance function has been enabled or disabled by the user in the current route section contrary to standard disablement or enablement in the digital map; and
to enable or disable the driver assistance function for use in the current route section according to the user-specific availability profile.

34. The device according to claim 17, wherein the device is further configured:
to ascertain use data relating to an actual use of the driver assistance function by the user; and
to take the use data as a basis for suggesting or automatically effecting an adaptation of the user-specific availability profile, the adaptation comprising:
an inclusion of a disabled or enabled route section in the user-specific availability profile; and/or
an adaptation of a maximum statistical frequency of terminations, takeover requests and/or errors in the driver assistance function that is accepted by the user.

35. The device according to claim 17, wherein:
the user-specific availability profile indicates a minimum takeover time as a result of a takeover request from the driver assistance function that is desired by a user; and
the device is further configured to enable or disable the driver assistance function in different use situations such that in each use situation, a takeover time required for operation of the driver assistance function is not less than the minimum desired takeover time.

36. A method for providing a driver assistance function of a motor vehicle, the method comprising:
ascertaining a user-specific availability profile relating to a user-related availability of the driver assistance function; and
disabling or enabling the driver assistance function based on the user-specific availability profile.
